(19) United States
(12) Patent Application Publication
(10) Pub. No.: US 2013/0163022 A1
(43) Pub. Date: Jun. 27, 2013

(54) Print System, Print Data Generating Device, Print Device, and Tangible Computer-Readable Recording Medium

(71) Applicant: Shinya Kuratomi, Atsugi (JP)

(72) Inventor: Shinya Kuratomi, Atsugi (JP)

(73) Assignee: Konica Minolta Business Technologies, Inc., Tokyo (JP)

(21) Appl. No.: 13/725,832

(22) Filed: Dec. 21, 2012

(30) Foreign Application Priority Data
Dec. 27, 2011 (JP) 2011-286860

(51) Int. Cl. G06F 3/12

(52) U.S. Cl. 358/1.13; 358/1.15

(57) ABSTRACT

Disclosed is a print system including a print data generating device to generate a variable print data, and a print device to carry out a print in accordance with the variable print data, wherein the print data generating device generates and outputs the variable print data including search information for searching and obtaining original information for a variable part from a database; and wherein the print device includes: an input unit to input the variable print data; a search unit to carry out a search for searching the original information in the database in accordance with the search information included in the variable print data; a processing unit to prepare a print image in accordance with the variable print data by reflecting searched information obtained by the search unit on the variable part; and a print unit to print the print image.

### BACKGROUND OF THE INVENTION

1. Field of the Invention

The present invention relates to a print data generating device and a tangible computer-readable recording medium for generating a print data for the merge print, and a print device and a print system for carrying out the printing in accordance with the print data for the merge print.

2. Description of Related Art

In recent years, digital print methods have been popularized in a commercial print market with the improvement in the image quality of the digital printer typified by an electrophotographic printer. In the digital printer methods, printed matters are prepared in accordance with the digital images generated from the print data described in the page description language (PDL) without using the blocks. Therefore, in the digital print methods, the variable print for printing out the documents so as to replace a part of the contents to be printed can be carried out. In the variable print, the original information the variable part to be replaced is generally database information, such as a customer management DB (Database) or the like.

In the variable print in which the database information is reflected, in general, the variable information which is the original information for the variable part is stored in the database form in the dedicated device for managing the database information. The variable information is extracted and obtained from the above database via a DBMS (Database Management System) by setting the search condition expression. For example, the variable information is stored as the text file like the CSV (Comma Separated Values) file.

In the print data generating device for generating the print data, in general, the layouting for the fixed part and the variable part in the page for the variable print is carried out in accordance with the GUI (Graphical User Interface) based program which is referred to as the VDP (Variable Data Printing) application program.

At this time, in the fixed part, the layouting, the loading of image files and the input of characters by using the keyboard, are carried out and the entities of the objects to be arranged in the fixed parts are set. In the variable part, in many cases, the layouting is related to the data field in the file for storing the variable data. As “the file for storing the variable data”, the text file, such as the CSV file, which is obtained by the above search from the database, is generally used.

As described above, after the layouting is related to the variable information in accordance with the VDP application, the process for generating the print data is carried out. In the print data to be generated, in general, the object, such as an image, characters, a graphic data and the like, is converted to a PDF (Portable Document Format) file. Further, the layout information indicating the position relation between the objects and the reuse/non-reuse of each object is converted to the data file compliant with the PPML (Personalized Print Markup Language) which is a standard language for the commercial variable print. The above files are output in the ZIP archive format.

As the technologies for generating the print data and the like in accordance with the information obtained from the database, for example, the following technologies have been proposed.

In Japanese Patent Application Publication No. 2010-279038, the following technology is disclosed. In this technology, the character string read out from the database is arranged so as to adjust the size of the character string to the rectangular box. After the image arranged in this box is nonlinerly deformed to an optional quadrangle, such as a trapezoid, by carrying out the rendering on the electronic image, for example, it is possible deform the character string and to combine the character string and an image of a building which is seen upwardly from the bottom so as to draw the character string on the wall of the building.

in Japanese Patent Application Publication No. 2007-293621, the technology for preparing the document in accordance with the data obtained by referring the database in which the contents are changed from moment to moment, several times at certain intervals, is disclosed.

In Japanese Patent Application Publication No. 2006-215819, the following document processing device is disclosed. In this document processing device, in case that a document compliant with a template file prepared by the variable print system is obtained by converting the document to a unique format, the document is constructed by the format to which the concept of the record is adopted and the process for the documents can be carried out in each concept of the original record.

In the above-described processes for generating the print data, the variable information is reflected on both of the PDF file and the PPML file by expanding the variable information in the file formats of the PDF file and the PPML file, respectively. Therefore, the objects of the all variable information obtained from the database, such as a character string, are prepared to convert them to the PDF files. Further, the PPML data for concretely specifying where the objects to be merged in each variable part a arranged in the PDF files, are generated for the printed matters of all cases of searched information obtained from the database.

Therefore, in case that there are many cases of variable information extracted from the database, the data generating time for reflecting each case of variable information on the PDF file and the PPML files, becomes longer. Further, the FPOT (First Print Output Time) becomes longer because of the increase in the data transfer time for transferring the data during the print, the unzipping time for unzipping the ZIP archive, and the time for scanning the layout information of the PPML file.

In particular, in an actual process, until the print data is generated, the process could be carried out by a client company or a design company. Then, the print could be carried out by a printing company. Therefore, the time that elapses from the generation of the print data until the start of the print could become longer. In this case, there is some possibility that the database has been updated when the print begins. Therefore, the problem that the contents stored in the updated database are not correctly reflected on the contents to be printed, may be caused.

### SUMMARY

To achieve at least one of the abovementioned objects, a print system reflecting one aspect of the present invention comprises:

a print data generating device to generate a variable print data, and a print device carryout a print in accordance with the variable print data generated by the print data generating device,

wherein the print data generating device generates and outputs the variable print data including search information for searching and obtaining original information for a variable part from a database; and

wherein the print device comprises:

an input unit to input the variable print data generated by the print data generating device;

a search unit to carry out a search for searching the original information in the database in accordance with the search information included in the variable print data which is input from the input unit;

a processing unit to prepare a print image in accordance with the variable print data by reflecting searched information obtained by the search unit on the variable part; and

a print unit to print the print image prepared by the processing unit.

Preferably, the processing unit of the print device generates an intermediate data in which print contents of the variable part on which the searched information is reflected are described in a predetermined page description language, and

the processing unit generates the print image of the variable part by rasterizing the intermediate data.

Preferably, in the print device, the search unit and the processing unit are operable in parallel, and the processing unit starts a process in accordance with the obtained searched information without waiting finish of the search carried out by the search unit.

Preferably, the search information includes connection information for connecting the database, a field name of a field in which the original information to be extracted is stored and a search condition expression.

Preferably, the variable print data includes layout information used as a template corresponding to a printed matter for one case of the searched information, and

the layout information for the variable part includes a field name indicating a source of the original information, format information and arrangement information indicating arrangement of the print image of the variable part in each page.

Preferably, the print data generating device comprises:

a layout setting unit to receive setting of a layout of a variable printed matter;

a search information setting unit to receive setting of the search information for searching and obtaining the original information for the variable part in the variable printed matter in which the setting of the layout is received by the layout setting unit; and

a generating unit to generate and output the variable print data including layout information indicating the layout of which the setting ing is received by the layout setting unit, an object of a fixed part designated in the layout and the search information.

Preferably, the print data generating device comprises:

a first input unit to input a first variable print data corresponding to at least one case of the searched information, first variable print data having a data format including layout information for all pages, objects of all fixed parts, and objects of all variable parts, which are prepared in accordance with the searched information obtained from the database;

a search information setting unit to receive setting of the search information for searching and obtaining the original information for preparing the objects of the variable parts, from the database; and

a converting unit to extract layout information and the objects of all fixed parts, which correspond to one case of the searched information, from the first variable print data which is input by the first input unit, to convert the extracted layout information to layout information used as a template for preparing the objects of the variable parts in accordance with the searched information obtained from the database, and to generate and output the variable print data including the layout information used as the template, the search information and the extracted objects of all fixed parts.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing an example of the system configuration of the print system according to the embodiment;

FIG. 2 is a block diagram showing the internal structure of the DB information management device;

FIG. 3 is a block diagram showing the internal structure the print data generating device;

FIG. 4 is a block diagram showing the internal structure of the print device;

FIG. 5 is a view showing an example of the printed matter obtained by the variable print;

FIG. 6 is a view showing an example of the edit window displayed on the monitor device during the layouting;

FIG. 7 is a view showing an example of the search information entering window;

FIG. 8 is a view showing an example of the PDF file and the PPML file in the print data generated by the print data generating device according to the embodiment;

FIG. 9 is a view showing an example of the PDF file and the PPML file in the print data generated in accordance with a conventional VDP application program;

FIG. 10 is an explanatory view showing the thread structure and the like in the print device and the DB information management device when the print process is carried out;

FIG. 11 is a flowchart showing the process in the PPML interpreter main thread;

FIG. 12 is a view showing an example of the page description data generated in Step 2206 of FIG. 11;

FIG. 13 is a flowchart showing the process in the DB search thread;

FIG. 14 is a view showing an example of the search condition expression according to the SQL sentence;

FIG. 15 is a view showing an example of the variable information storing table in which the searched information is stored;

FIG. 16 is a view showing the search condition expression according to the SQL sentence in case that the dummy data is generated; and

FIG. 17 is a view showing an example of the search information entering window displayed in accordance with the print data conversion program.

### DETAILED DESCRIPTION OF PREFERRED EMBODIMENTS

Hereinafter, a prefer embodiment present invention will be explained with reference to the accompanying drawings.

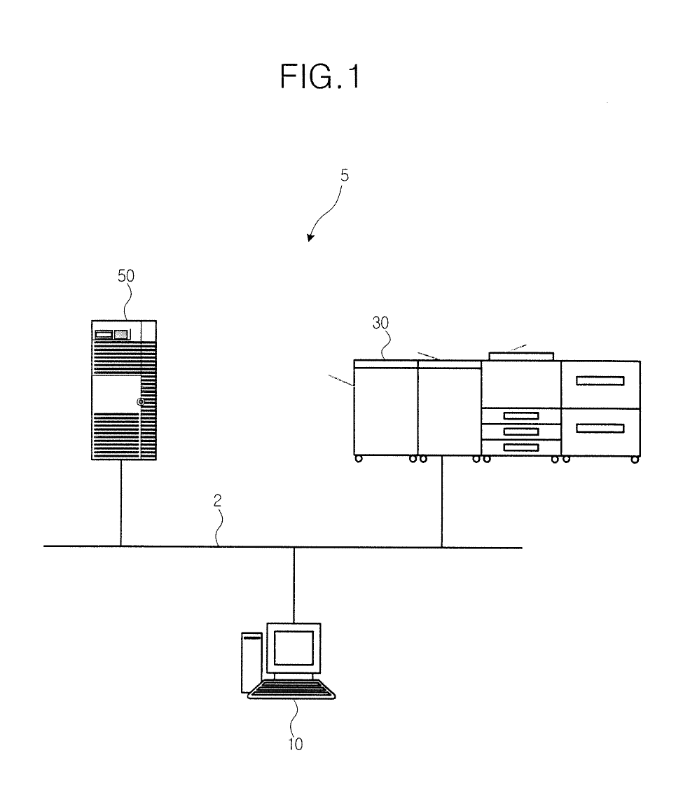

FIG. 1 shows an example of the system configuration of the print system 5 according to the embodiment. The print system 5 comprises a print data generating device 10 and a print device 30. The print data generating device 10 and the print device 30 are connected with a DB information management device 50 via a network 2. The DB information management device 50 is a device for managing the database, such as a customer database.

The print system 5 carries out the variable print. The variable print is a print method in which a part of the objects in one set of printed matter composed of one or more pages is replaced and any number of sets of printed matter are prepared by printing the objects. The part to be replaced is referred to as the variable part. The common part to all of the sets of printed matter is referred to as the fixed part. In particular, the object to be arranged to the fixed part is referred to as the reusable object.

In the print system 5, the print data generating device 10 generates the variable print data including the search information for obtaining the original information for the variable part (referred to as “variable information”) from the database. The print device 30 searches the variable information in the database (DB information management device 50) in accordance with the search information included in the variable print data when the print is carried out. Further, the print device 30 carries out the print based on the variable print data by reflecting the searched information on the variable cart.

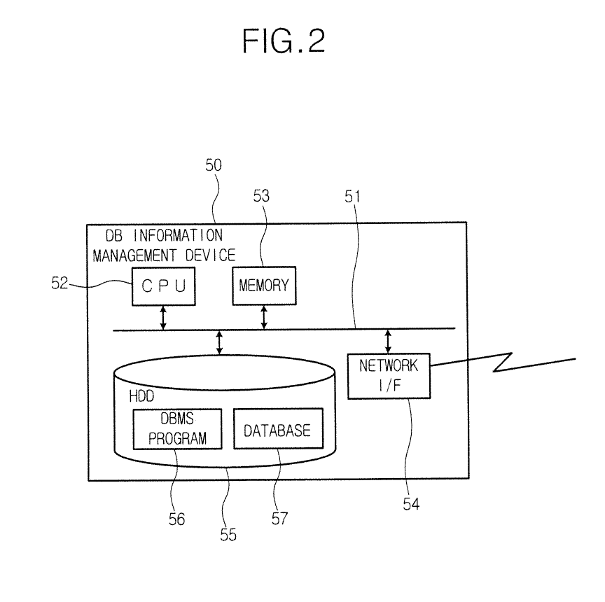

FIG. 2 shows the internal structure of the DB information management device 50. The DB information management device 50 comprises a CPU (Central Processing Unit) 52, a memory 53, a network I/F 54, an HDD (Hard Disk Drive) 55 and the like, which are connected with each other via a system bus 51.

The HDD 55 is used for storing the DBMS (Database Management System) program 56 and the database 57. The DBMS program 56 is executed by the CPU 52 after the DBMS program 56 is loaded on the memory 53. The database 57 stores the variable information for the variable print. In the database 57, various types of information, such as address, name, age, gender, purchase history, academic achievement, health examination result information or the like, is stored according to the types of variable print.

The DB information management device 50 receives the search request for the DBMS program 56 via the network I/F 54. Further, the DB information management device 50 carries out the search in accordance with the search condition included in the search request, and transmits the searched information to the search request source via the network I/F 54.

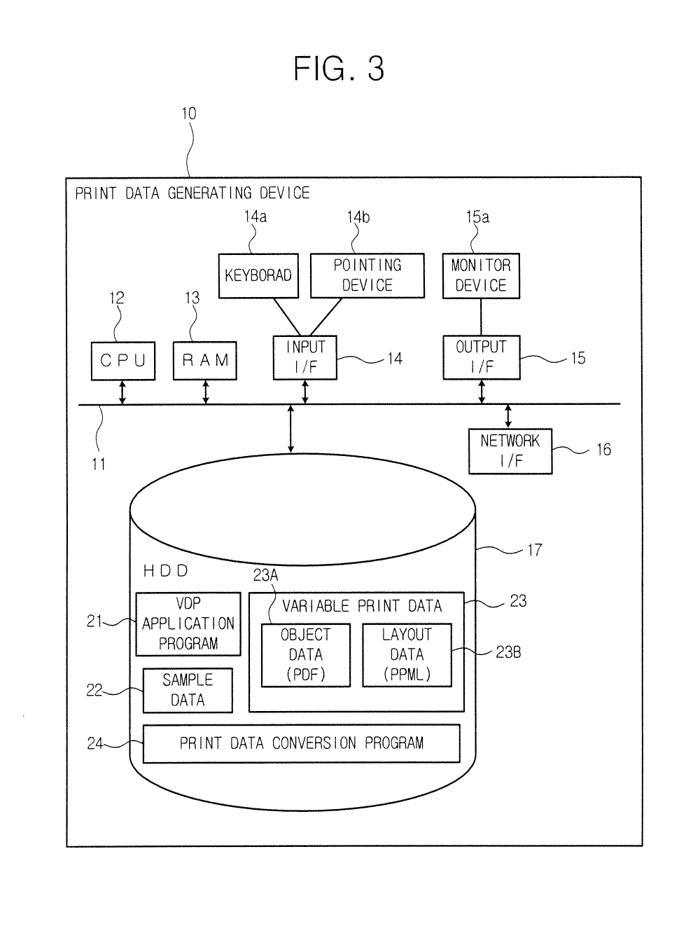

FIG. 3 shows the internal structure of the print data generating device 10. The print data generating device 10 comprises a CPU 12, a RAM (Random Access Memory) 13, an input I/F 14, an output I/F 15, a network I/F 16, an HDD 17 and the like, which are connected each other via a system bus 11. A keyboard 14a and a pointing device 14b, such as a mouse, which are input devices for inputting the user operation, are connected to the input I/F 14. The keyboard 14a is used for inputting characters. The pointing device 14b is used for pointing an object image or the like. A monitor device 15a for displaying an image for the print preview and various types of windows, is connected to the output I/F 15.

The HDD 17 is used for storing a VDP application program 21 which is a program for generating variable print data, sample data 22, variable print data (for example, the variable print data having the ZIP format) 23, a print data conversion program 24 and the like.

The VDP application program 21 is executed by the CPU 12 after the program 21 is loaded on the RAM 13. The VDP application program 21 is a GUI based program. By the VDP application program 21, the print data generating device 10 receives the user operation for editing the image via the keyboard 14a and the pointing device 14b, and displays the image to be edited on the monitor device 15a.

The sample data 22 includes various types of data, such as an image data which is loaded and arranged in the image for the print preview by the VDP application program 21.

The variable print data 23 is data having the ZIP archive format, which is generated by the VDP application program 21. The variable print data 23 includes the object data 23A and the layout data 23B. The object data 23A is a PDF file. The layout data 23B is, for example, a data file having the PPML format.

The print data conversion program 24 is used for converting the variable print data generated by a conventional VDP application program (referred to as “conventional variable print data”) to the variable print data according to the embodiment (referred to as “present variable print data”). The conventional variable print data to be converted may be a dummy data corresponding to one case of searched data.

The variable print data 23 generated in the print data generating device 10 or obtained by converting the conventional variable print data, is transmitted to an external device, such as the print device 30 via the network I/F 16. The print data generating device 10 is configured so as to enable the generated variable print data to be written in a portable recording medium, such as a USE memory.

The print data generating device 10 is configured by a dedicated device. Alternatively, the print data generating device 10 may be realized by using a general-purpose computer executing the program for functioning as the print data generating device 10.

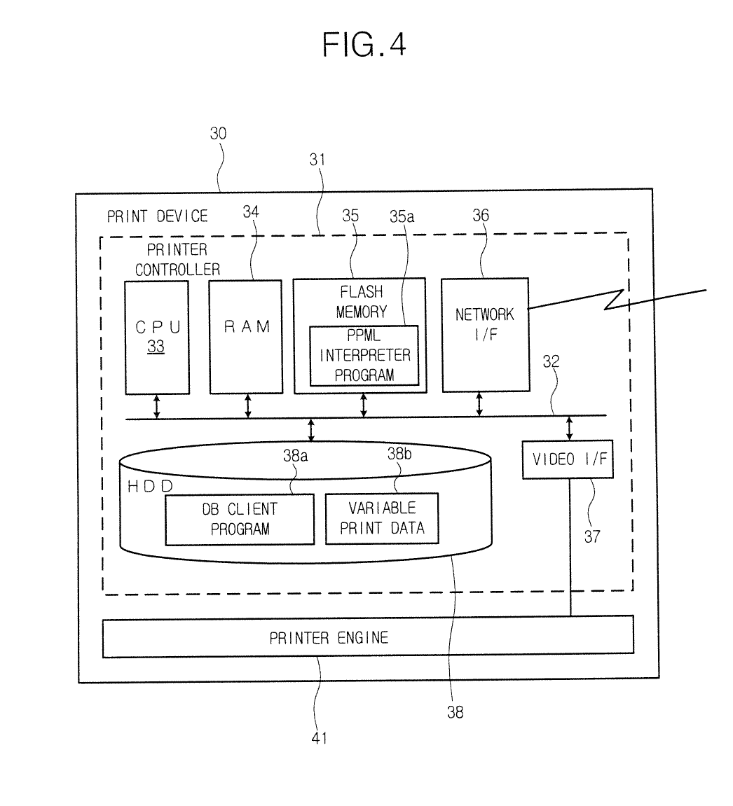

FIG. 4 shows the internal structure of the print device 30. The print device 30 comprises a printer controller 31 and a printer engine 41. The basic function of the printer controller 31 is to prepare a print image in accordance with the variable print data received from the print data generating device 10 and to transmit the prepared print image to the printer engine 41.

The printer controller 31 comprises a CPU 33, a RAM 34, a flash memory 35, a network I/F 36, a video I/F an HDD 38 and the like which are connected with each other via a system bus 32.

The CPU 33 controls the whole operations of the printer controller 31. The RAM 34 is used as a work memory temporarily storing various types of data when the CPU 33 executes the program, and as a cache memory for storing the reusable object image which is a raster image obtained by carrying out the raster image processing (RIP) for the reusable object.

In the flash memory 35, the PPML interpreter program 35a for generating the raster image from the variable print data, and the like are stored. The PPML interpreter program 35a is executed by the CPU 33 after the program 35a is loaded.

The network I/F 36 carries out the communication with the print data generating device 10. Further, the network I/F 36 transmits the search request for the variable information to the DE information management device 50 and receives the search result of the search request. The HDD 38 is a large capacity and nonvolatile storing device. In the HDD 38, a DB client am 38a and the variable print data 38b received the print data generating device 10, are stored.

The print image prepared by the printer controller is temporarily stored in the RAM 34. Then, the print image is transferred to the printer engine 41 via the video I/F 37.

The printer engine 41 forms an image on the recording paper in accordance with the print image transferred from the printer controller 31 to prepare the final printed matter. The printer engine 41 is configured as the electrophotographic type of printer engine for forming an image on recording paper by the electrophotographic process. The printer engine 41 comprises, for example, a conveying device for the recording paper, a photoconductive drum, a charging device, a laser unit, a developing device, a transfer and separation device, a cleaning device and a fixing device. The printer engine 41 may be an inkjet type of printer engine or another type of printer engine.

Next, the print data generating process which is carried out by the print data generating device 10, will be explained.

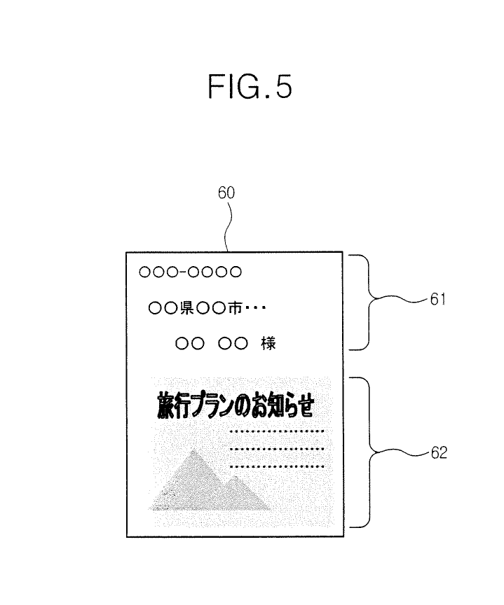

FIG. 5 shows an example of the printed matter 60 prepared by the variable print. The printed matter 60 of this example is a direct mail prepared by extracting the zip code, the address and the name of the customer which meets the specific search condition, from the customer master database as variable information, and by reflecting the extracted information on the variable part 61. The lower part of the direct mail is the fixed part 62 which is the common part to the all of the direct mails. In the fixed part 62, the image and characters are arranged. In the printed matter 60 shown in FIG. 5, one set of the printed matter 60 is composed of one page. Hereinafter, the operation of the print system 5 will be explained by exemplifying the case that the variable print for the printed matter 60 of FIG. 5 is carried out.

The user starts up the VDP application program in the print data generating device 10. Further, while the user confirms the image to be edited or the like by using the monitor device 15a, the user carries out the layouting and entries the search information for searching variable information in the database by using the keyboard 14a and the pointing device 14b in order to prepare the printed matter 60.

At the layouting, with respect to the fixed part, the designation of the object, the setting operation for setting the size adjustment and the arrangement for the designated object and the like are received. With respect to the variable part, the entry of the field name which is the source of the original information for the variable part, and the setting operation for setting the format and the arrangement for the variable part, are received.

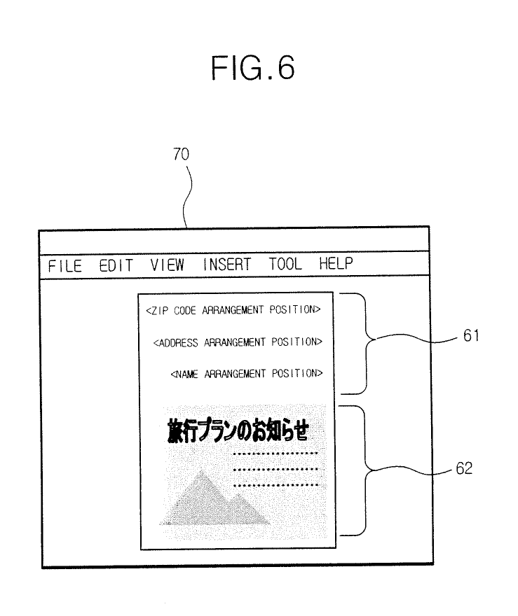

FIG. 6 shows an example of the edit window displayed on the monitor device 15a while the print data generating device 10 which operates in accordance with the VDP application program 21 carries out the layouting. FIG. 6 shows the display state in which the layouting for the printed matter 60 is finished.

In the fixed part 62, the entity of the object, which is a sample data (image part) loaded from the HDD 17 and the input characters or the like is directly displayed. In the variable part 61, the entity of the object is not displayed, and the field names in the database in which the original variable information of the object to be arranged in the variable part 61 is stored, are displayed. The format set to the text of the field name displayed in the variable part 61 is reflected on the object arranged on this variable part at the print. The variable part 61 and the fixed part 62 to be moved can be selected and the selected part can be moved by using the pointing device 14b. Further, the format, such as the size, the type of font, the decoration and the like of the characters arranged in the variable part 61, is set by the predetermined format setting operations.

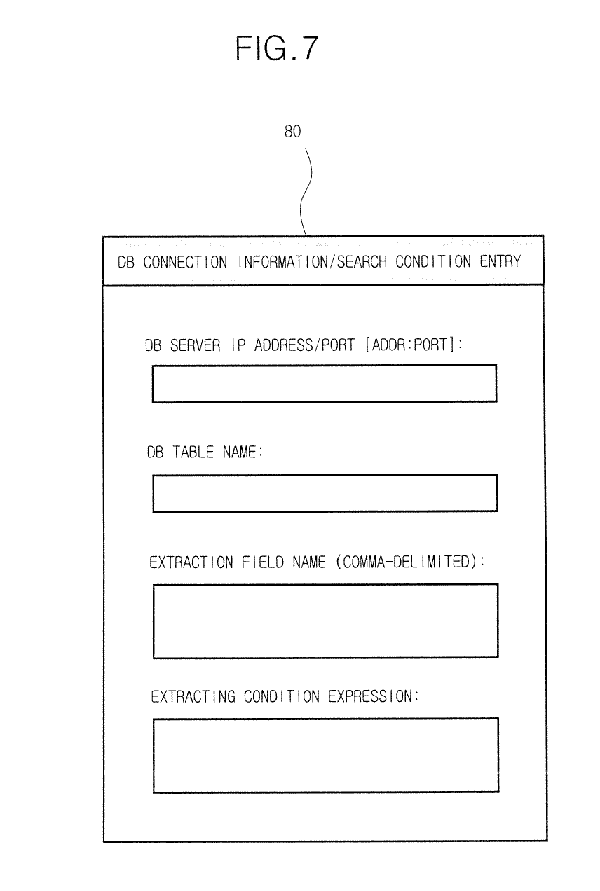

FIG. 7 shows an example of the search information entering window 80 for entering the search information for the database. The print data generating device 10 which operates in accordance with the VDP application program 21 displays the search information entering window 80 on the monitor device 15a. In the search information entering window 80, the entry of the connection information relating to the connection to the database, the entry of the search conditions and the like are received. In detail, the entry of each type of information, such as the IP address of the destination DB server, the DB table name, the extraction field name, the extracting condition, and the like, is received. In the extraction field name, the field names are entered as required by separating them with commas. For example, in case that the search information relating the printed matter 60 is set, three fields which are the zip code, the address and the name, are set as the extraction field names. The field names entered in the edit window 70 at the layouting, may be automatically displayed in the box of the extraction field name in the search information entering window 80.

After the settings of the layouting and the search information are finished, the print data generating device 10 which operates in accordance with the VDP application program 21 carries out the variable print data generating process. The variable print data generating process is started by executing the GUI based command in the VDP application program. Further, in the variable print data generating process, the PDF file and the PPML file are prepared in accordance with the layout set in the edit window 70 and the search information set in the search information entering window 80, and the prepared files are converted to the ZIP format to output them.

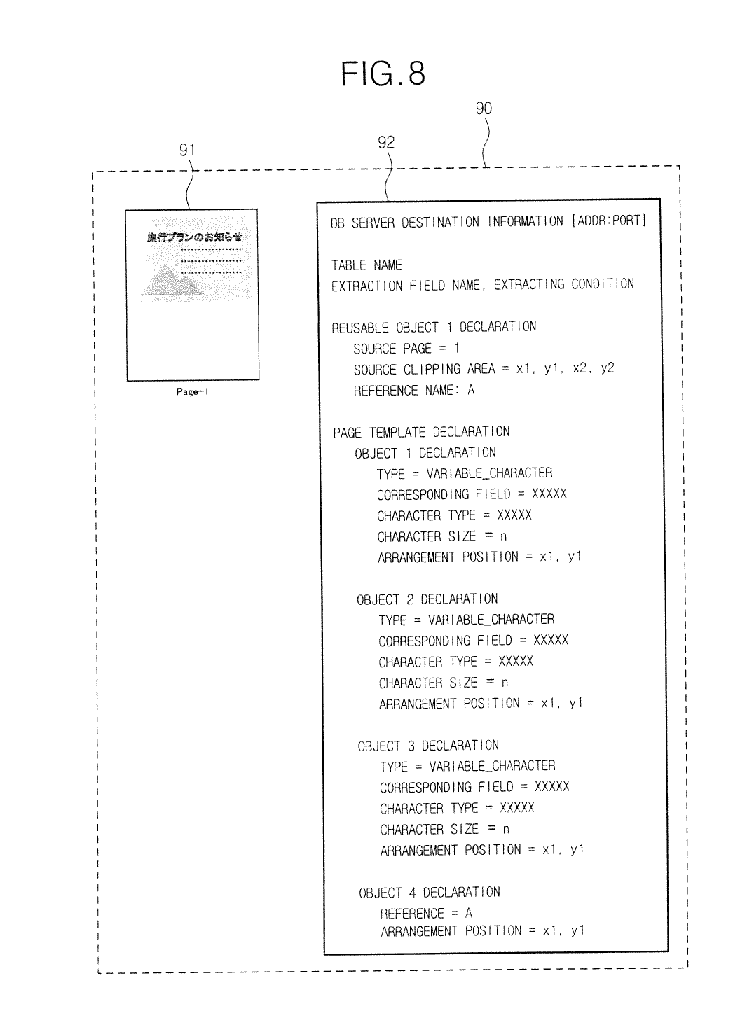

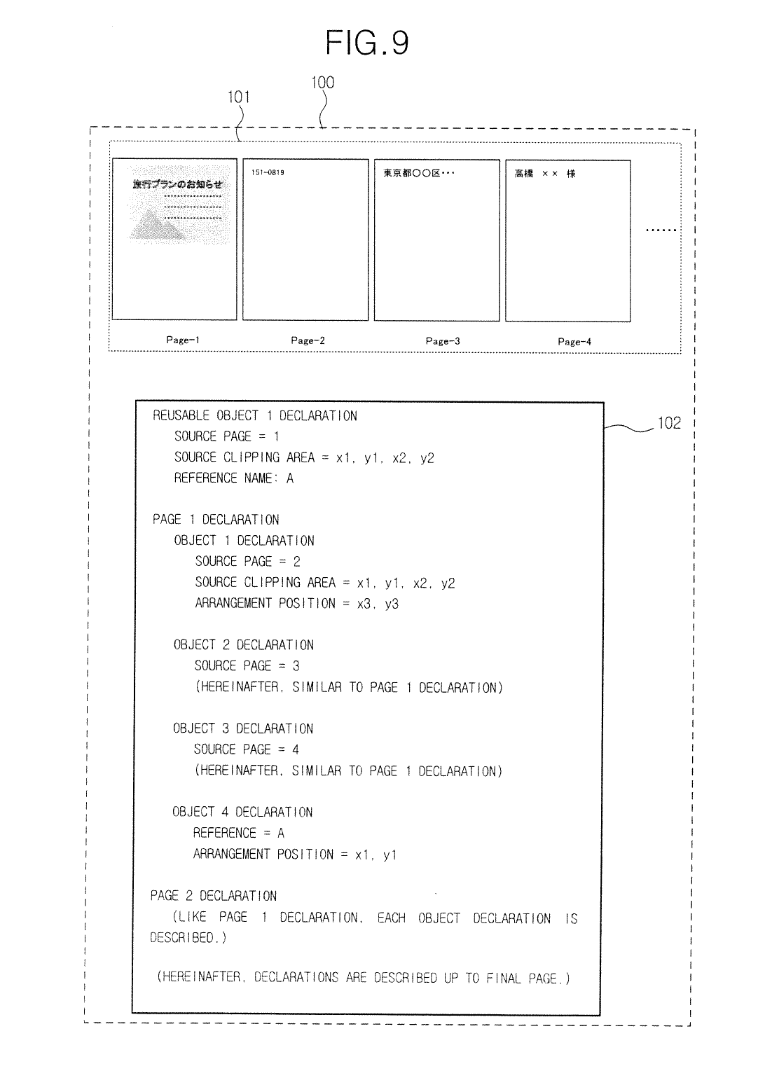

FIG. 8 shows an example of the PDF file 91 and the PPML file 92 in the variable print data 90 generated by the print data generating device 10 according to the embodiment. In order compare the embodiment with the conventional variable print data, FIG. 9 shows the PDF file 101 and the PPML file 102 in the variable print data 100 generated in the conventional VDP application program.

By the conventional VDP application program, when the variable print data 100 is generated, the variable information is searched in the database and the PDF file 101 and the PPML file 102 on which the variable information extracted in accordance with all of the search results is reflected, are prepared. In the PDF file 101, the object of the fixed part and all of the objects obtained in accordance with all of the search results, which are arranged in the variable part of the printed matter, are stored. In the example shown in FIG. 9, in page 1 of the PDF file 101, the object to be arranged in the fixed part is stored. In pages 2 to 4 of the PDF file 101, the objects to be arranged in the variable part of the first set of the printed matter, are stored. In pages 5 to 7, the objects to be arranged in the variable part of the second set of the printed matter, are stored. In pages 8 to 10, the objects to be arranged in the variable part of the third set of the printed matter, are stored. As described above, all of the objects to be arranged in the variable parts, which are obtained in accordance with all of the search results are stored.

In the PPML file 102 prepared by the conventional VDP application program, the declaration of the reusable object and the page declarations of all pages in the printed matter, which correspond to all of the search results, are described. In the declaration of the reusable object, the page number of the PDF file in which the reusable object is stored, the clipping area and the reference name, are described. In the PDF file shown in FIG. 9, “Reusable object 1 declaration” is described.

The page declaration includes the layout information for one page. In the page declaration, the declarations of the all of the objects to be printed on this page, are described. In the declaration of the reusable object arranged in the fixed part, the reference and the information relating to the arrangement position in this page, are described. In the reference, the reference name of the reusable object in this declaration is described. In the declaration of the object arranged in the variable part, the page number of the PDF file in which this object is stored, the clipping area and the information relating to the arrangement position in this page, are described. In the example of FIG. 9, in the page 1 declaration, as the object declarations of the variable part, “Object 1 declaration”, “Object 2 declaration” and “Object 3 declaration” are described. As the object declaration of the fixed part, “Object 4 declaration” is described. Like the page 1 declaration, the page declarations of all subsequent pages are described.

On the other hand, as shown in FIG. 8, in the PDF file 91 of the variable print data 90 generated by the print data generating device 10 according to the embodiment, only the object arranged in the fixed part is stored. In the PPML file 92, the search information for the database, the declaration of the reusable object arranged in the fixed part and the page template declaration are described.

As the search information for the database, the contents which are entered in the search information entering window 80, are described. In the declaration of the reusable object, like that of FIG. 9, the page number of the PDF file in which the reusable object is stored, the clipping area and the reference name, are described.

The page template declaration includes the layout information for one page, which is the origin of a template. In the page template declaration, the declarations of all objects to be arranged in this page, are described.

For the objects to be arranged in the variable part, various types of information, such as type, corresponding field, character type, character size, arrangement position, and the like is described. The type indicates whether the object designated in this declaration shows characters or an image which is prepared in accordance with the variable information. In case of characters, “Variable_character” is described. In case of an image, “Variable_image” is described.

The corresponding field indicates the field name in the database in which the variable information which is the origin of the object designated in this declaration is stored. In the character type and the character size, the values set in the edit window 70 are described. In the arrangement position, the arrangement position in this page, which is set in the edit window 70 is described as the coordinate information.

For the object to be arranged in the fixed part, the information relating to the reference and the arrangement position is described, in the reference, the reference name or the reusable object designated in this declaration is described. In the arrangement position, the arrangement position in this page, which is set in the edit window 70 is described as the coordinate information.

In the example shown in FIG. 8, as the page template declaration, “Object 1 declaration”, “Object 2 declaration” and “Object 3 declaration” which are the declarations for the objects to be arranged in each variable part, are described. Further, “Object 4 declaration” which is the declaration for the reusable object to be arranged in the fixed part, is described.

Next, the operations of the print device 30 and the DB information management device 50, for carrying out the print in accordance with the variable print data generated by the print data generating device 10, will be explained.

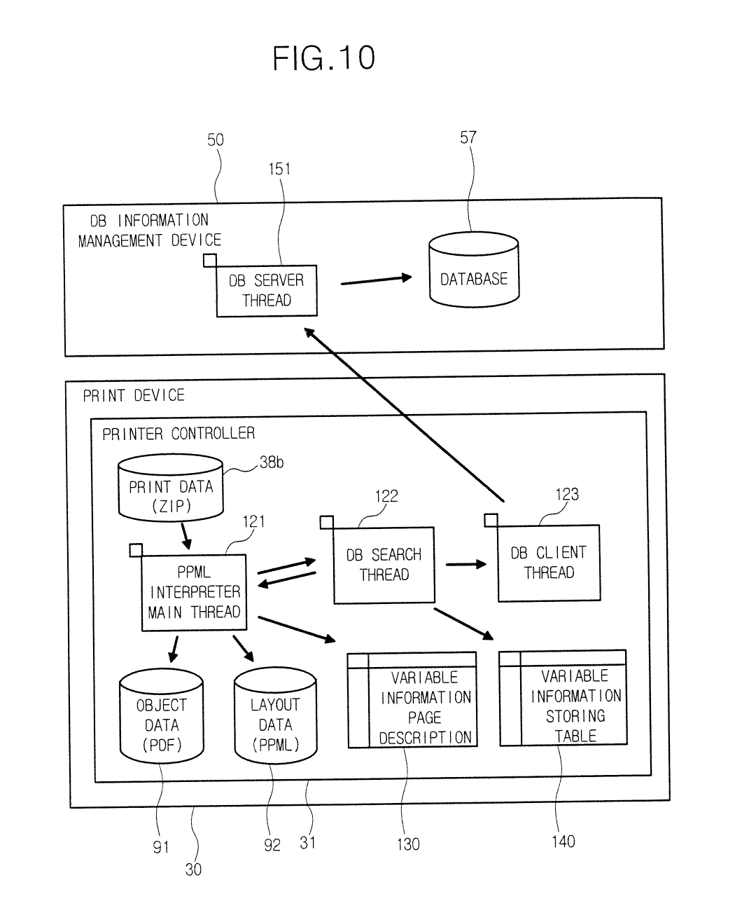

FIG. 10 shows the thread structure and the like in the print device 30 and the DB information management device 50, for carrying out the print process. The PPML interpreter main thread 121 and the DB search thread 122 of the print device 30 are prepared in accordance with the PPML interpreter program 35a shown in FIG. 4. Each thread can be operated in parallel.

The DB client thread 123 is prepared in accordance with the DB client program 38a. The DB server thread 151 of the DB information management device 50 is prepared in accordance with the DBMS program 56.

The PPML interpreter main thread 121 is a main process thread for carrying out the print process in accordance with the variable print data. After the ZIP format of the variable print data generated by the print data generating device 10 is read and the variable print data is unzipped to obtain the PDF file 91 and the PPML file 92, the process for preparing the print image in accordance with the contents of the obtained two files is carried out.

The DB search thread 122 is a thread for searching the variable information in the database by receiving the search information for the database (the extraction field name and the extracting condition) described in the PPML file 92, from the PPML interpreter main thread 121. By the DB search thread 122, the search result of the above search is stored in the variable information storing table 140. When the request for obtaining the variable information is received from the PPML interpreter main thread 121, the process for returning the variable information stored in variable information storing table 140 the PPML interpreter main thread 121 case by case is carried out by the DB search thread 122.

By operating the PPML interpreter main thread 121 and the DB search thread 122 in parallel so as to separate them, the process for preparing the print image can be carried out by PPML interpreter main thread 121 without waiting the finish of all searches. That is, even though it takes a comparatively long time to obtain all of the search results because the number of the records which meet the search conditions is large, is possible to carry out the print image preparing process by the PPML interpreter main thread 121 if there is at least one case of the unprocessed variable information in the variable information storing table 140. Thereby, even though the print device 30 searches the variable information in the database at the start of the print, it is possible to minimize the delay of the print due to the waiting time for the search results.

The DB client thread 123 is a thread for outputting the actual DB search request in response to the request from the DB search thread 122, and corresponds to the client function of the DBMS package.

The DB server thread 151 of the DB information management device 50 is a thread for receiving the DB search request output by the DB client thread 123 of the print device 30, for searching the variable information in the database 57 and for returning the search result. The DB server thread 151 corresponds to the server function of the DBMS package.

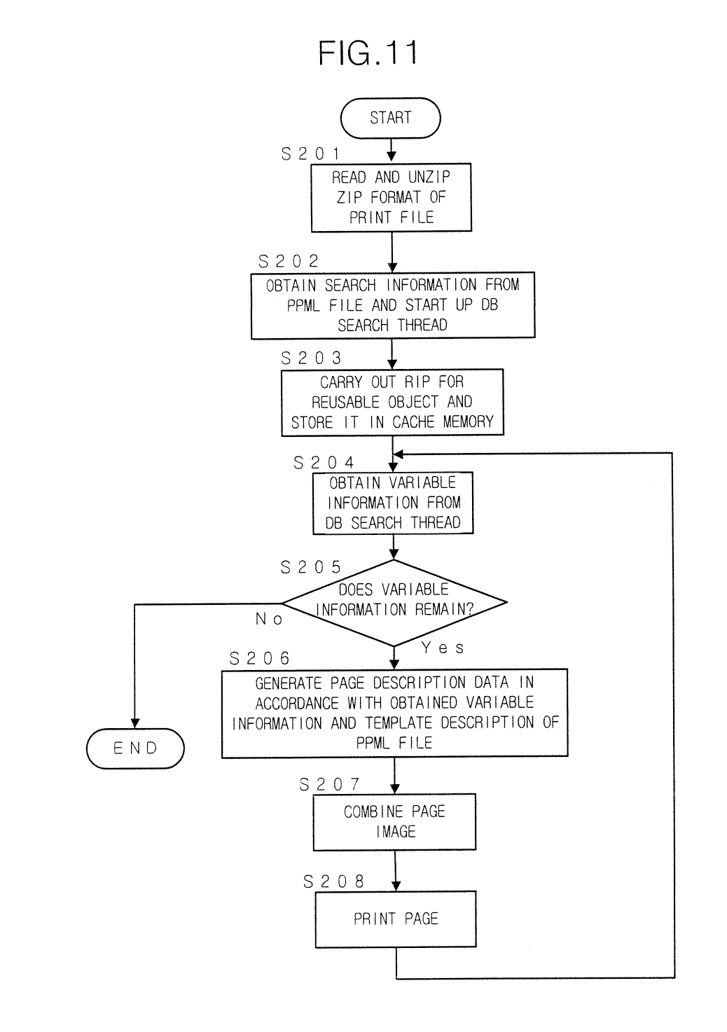

FIG. 11 shows the flowchart of the process in the PPML interpreter main thread 121. By the PPML interpreter main thread 121, the ZIP format of the variable print data is read, and is unzipped to obtain the PDF file 91 and the PPML file 92. Then, the obtained two files are scored in the HDD 38 (Step S201). Next, the connection information for connecting the database and the search conditions (the extraction field name and the extracting condition) are obtained from the head part of the obtained PPML file 92 to start up the DB search thread 122 by using the connection information and the search conditions as parameters (Step S202).

Next, by the PPML interpreter main thread 121, the declaration of the reusable object is read from the PPML file 92. The reusable object corresponding to the declaration is rasterized and is expanded to the image data (RIP) and the image data of the reusable object (referred to as “reusable object image”) is stored in the cache memory of the RAM 34 (Step S203).

Then, while the variable information is obtained, the following process is sequentially carried out. In this process, the object is expanded to the intermediate data in accordance with the page description language and then is expanded to the raster image to prepare the object image to be arranged in the variable part. Then, the print image for one page is prepared by combining the object image and the reusable object image stored in the cache memory and is transferred to the printer engine 41 to print it on the recording paper.

In detail, the information obtaining request for obtaining the next variable information is transmitted to the DB search thread 122. Further, the variable information which is returned from the DB search thread 122 in response to the information obtaining request is received (Step S204). Next, it is judged whether the contents returned from the DB search thread 122 indicate that there is remaining variable information (Step S205). When there is no remaining variable information (Step S205; No), the process is ended. Incase that there is no remaining variable information, “End of data” is returned from the DB search thread 122.

When there is remaining variable information (Step S205; Yes), because the variable information is returned from the DB search thread 122, the page description data which is the intermediate data having the PDL format is generated in accordance with the returned variable information and the description contents in the page template declaration of the PPML file 92 (Step S206).

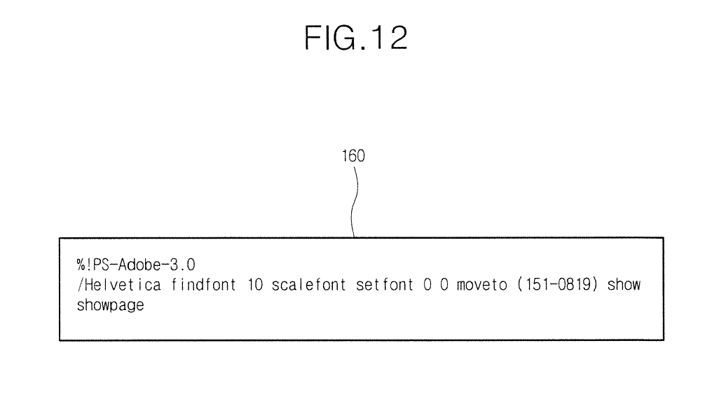

FIG. 12 shows an example of the page description data 160 generated in Step S205. The page description data 160 is a PostScript data indicating that the character string “151-0819” is printed under the conditions in which the character type is Helvetica and the character size is 10 points. The process for generating the page description data corresponding to the variable information is carried out for the object declarations of all variable parts described in the page template declaration. Incase of the PPML file 92 shown in FIG. 8, the page description data are generated for the Object 1 declaration, the Object declaration and the Object 3 declaration, respectively.

Next, the image for the variable part is prepared by carrying out the RIP for the page description data generated in Step S206. Then, the print image for one page is prepared by combining the prepared image and the reusable object image specified in the object declaration of the fixed part described in the page template declaration (Step S207).

The print image prepared in Step S207 is transferred to the printer engine 41 to print it (Step S208). That is, by transferring the prepared print image to the printer engine 41 via the video I/F 37, the print of the page is carried out.

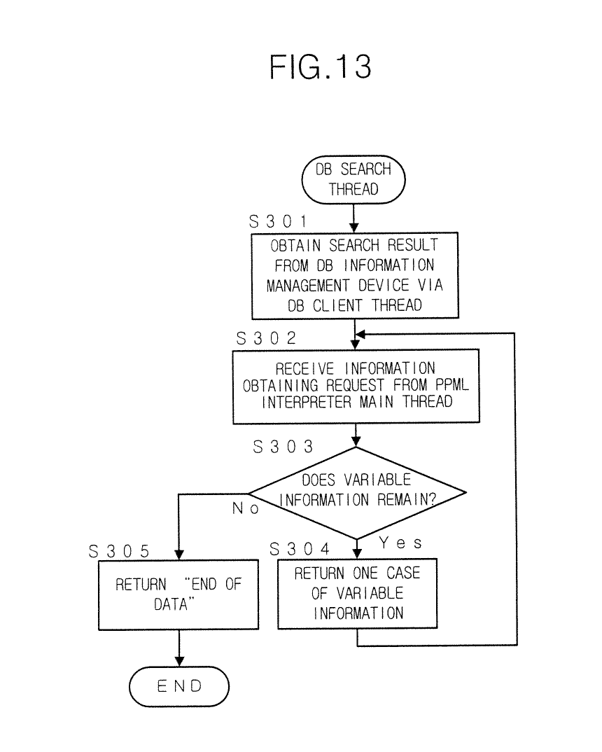

FIG. 13 shows the flowchart of the process in the DE search thread 122 of the print device 30. When the DB search thread 122 is started up by the PPML interpreter main thread 121, the DB search thread 122 instructs the DB information management device 50 to carry out the search in accordance with the parameters sent from the PPML interpreter main thread 121, and obtains the search result to store it in the variable information storing table 140 (Step S301). In detail, the print device 30 accesses to the DB server thread 151 of the DB information management device 50 via the DB client thread 123 by using the IP address of the DB information management device 50 and the port sent as parameters from the PPML interpreter main thread 121. Further, the search condition expression is prepared according to the SQL sentence from the search information sent as parameters at the starting-up of the DB search thread 122, that is, the table name, the extracting field information and the extraction condition. Then, the search condition expression is transmitted to the DB server thread 151 via the DB client thread 123 to carry out the search and obtain the search result. Then, the obtained search result is stored in the variable information storing table 140. In the GB client thread 123, the process proceeds to Step S302 without waiting until all of the search results are obtained. The process of Step S301 and the subsequent process from Step S302 are carried out in parallel.

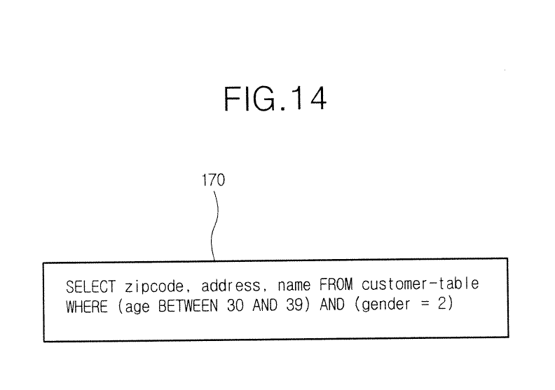

FIG. 14 shows an example of the search condition expression 170 according to the prepared SQL sentence. In this example, the zip code, the address and the name of each woman in her 30s are extracted from the table having the table name “customer-table”.

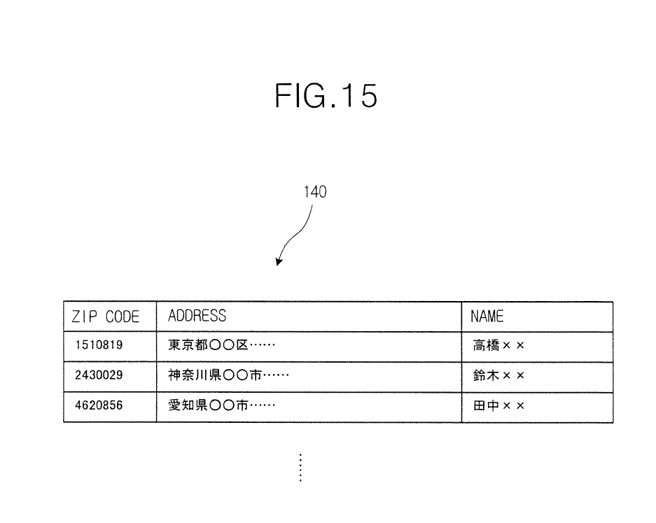

FIG. 15 shows an example of the variable information storing table 140 in which the searched information obtained from the database is stored. In FIG. 15, the information stored in one line indicates one case of data (variable information). In this example, one case of data is the variable data including three fields which are the zip code, the address and the name.

In FIG. 13, the subsequent process from Step S302 is carried out every when the information obtaining request for obtaining one case of variable information is received from the PPML interpreter main thread 121. When the DB client thread 123 receives the information obtaining request from the DB search thread 122, it is judged whether there are one or more cases of variable information which has not been transmitted in the variable information storing table 140 (Step S303). When there is at least one case of the variable information which has not been transmitted in the variable information storing table 140 (Step S303; Yes), one case of the variable information is transmitted to the PPML interpreter main thread 121 (Step S304). Then, the process returns to Step S302. When there is no variable information which has not been transmitted S303; No), “End of data” indicating that there is no remaining variable information is returned (Step S305). The process is ended.

As described above, in the print system 5 according to the embodiment, the print data generating device 10 generates the variable print data including the search condition for the variable information and the print device 30 carries out the actual search when the print is carried out. Therefore, it is possible to shorten the time for generating the variable print data, to minimize the data size and to shorten the time for transmitting the data to the print device 30. Further, because the variable part is prepared by obtaining the variable information from the database when the print is carried out, it is possible to obtain the printed matter in which the contents stored in the updated database are reflected.

Further, the page description data described in the page description language is generated as the intermediate data in accordance with the variable information obtained from the database and the PPML data (in particular, the format information, such as the character size, the character type and the like which are included in the object declaration for the variable part). Then, the print image of the variable part is prepared by carrying out the RIP for the page description data. Therefore, it is possible to use the existing RIP process program corresponding to the page description language in the RIP process.

Next, the operation for converting the conventional variable print data to the present variable print data in accordance with the print data conversion program 24, will be explained. In this explanation, the variable print for the printed matter 60 shown in FIG. 5, is exemplified.

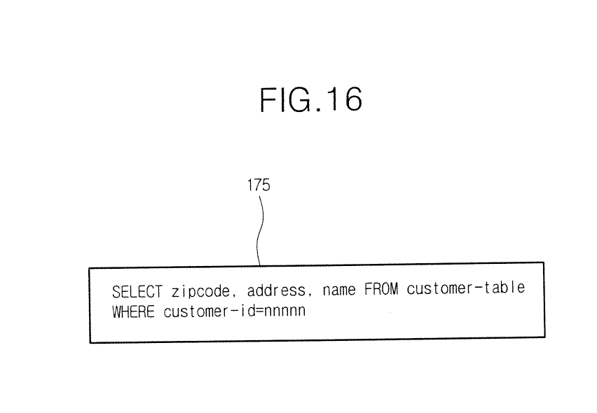

The SQL search is executed for the DB information management device 50 to obtain the customer data. In this example, the outputted SQL sentence is described as the search condition expression 175 shown in FIG. 16. In the search condition expression 175, the where clause “WHERE (age BETWEEN 30 AND 39) AND (gender=2)” which is the condition designation part described in the search condition expression 170 shown in FIG. 14 is replaced with “WHERE customer-id=nnnnn” (nnnnn indicates the actual customer ID.). By the SQL sentence, only one case of data is obtained. The one case of data is a dummy data which is conveniently obtained to normally proceed the subsequent process.

Next, the user starts up the conventional VDP application program and carries out the layouting to prepare the printed matter 60 by using the keyboard 14a and the pointing device 14b while the user confirms the image by using the monitor device 15a. Further, by the conventional VPD application program, the process for generating the conventional variable print data is carried out by using the one case of customer data obtained by the above search as the variable data. Thereby, the data is generated like the PD file 101 and the PPML file 102 which are shown in FIG. 9. However, in this example, only the data for one customer is generated. The above-described process can be carried out by an optional device, such as a computer device, which is different from the print data generating device 10. In case that the above optional device generates the conventional variable print data, the generated conventional variable print data is input to the print data generating device 10.

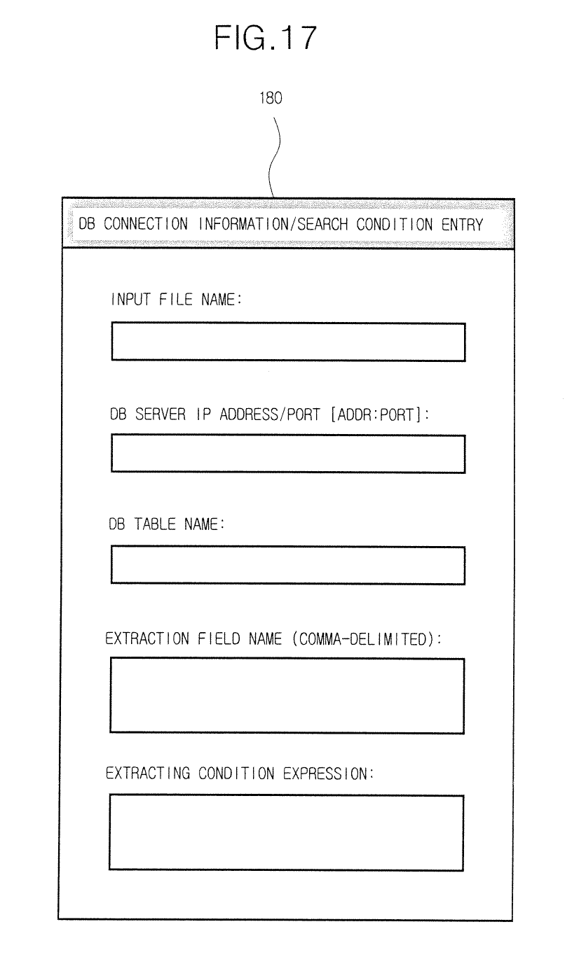

Next, the user starts up the print data conversion program 24. By the print data conversion program 24, the search information entering window 180 shown in FIG. 17 is displayed on the monitor device 15a of the print data generating device 10. The difference between the search information entering window 180 and the search information entering window 80 shown in FIG. 7, is that the entering space for entering the input file name exists in the search information entering window 180.

In the space for the input file name, the file name of the conventional variable print data generated by the conventional VDP application program is entered. The other information to be entered, is the same as that of the search information entering window 80 shown in FIG. 7. At this time, the user enters the information except the extraction field name.

Next, by the print data conversion program 24, the conventional variable print data having the entered input file name is read out, and the print image is prepared in the above the conventional variable print data to display the print image on the monitor device 15a. Then, each variable part in the displayed print image is displayed so as to identify each variable part, for example, by enclosing it with the predetermined mark. In this state, the user is instructed to select the variable part one by one and to enter the field name of the field in which the original information for the variable part is stored and the character size, the character type and the like for the variable part. In this example, when the selection of the any one of the variable parts in the print image displayed on the monitor device 15a is received, the dialog boxes for entering the field name, the character size and the character type for the selected variable part are displayed in a pop-up display to receive the entry of the above information from the user. The character type and the character size can be automatically set by analyzing the image. Alternatively, the character type and the character size which are automatically recognized can be displayed by default and then the user's agreement or the user's changing operation can be received.

After the entry of the information for all of the variable parts is finished, the process for converting the conventional variable print data to the present variable print data shown in FIG. 8, is carried out in accordance with the print data conversion program 24.

In detail, incase of the PDF file, only the pages in which the objects for the fixed part are stored are not deleted, and the other pages (the pages in which the objects for the variable part are stored) are deleted. Each page number of the pages in which the objects for the fixed part are stored is recognized from the source page described in the reusable object declaration of the conventional PPML file.

The PPML file is converted as follows. The search information for the database is described in accordance with the information entered in the search information entering window 180. In case of the declaration of the reusable object, the information of the conventional PPML file is directly used.

In the page template declaration, after the declaration of the first page (page 1 declaration) in the conventional PPML data is copied, each object declaration for the variable part included in the page 1 declaration is rewritten. The judgment for judging whether each object declaration described in the page 1 declaration of the conventional PPML data is the object declaration for the variable part is carried out. For example, when the object declaration includes the description relating to the source page, it is judged that the above object declaration is one for the variable part.

Next, in the object declaration for the variable part, the description relating to the source page and the source clipping area is deleted. Further, the information relating to the type, the corresponding field, the character type and the character size is described. In this description, the information relating to the field name, the character and the character size, which is entered for each variable part from the user by displaying the print window on the monitor device 15a, is used.

As described above, by using the print data conversion program 24, it is possible to convert the conventional variable print data to the present variable print data. For example, even though the conventional variable print data generated in accordance with the conventional VDP application program is transmitted from the customer, it is possible to carry out the variable print in which the contents of the updated database are reflected, by converting the conventional variable print data to the present variable print data at the printing company.

The print data conversion program 24 may be executed by a general computer.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

In the embodiment, the case in which one page is prepared for one case of the search result (the case in which one set of printed matter is composed of one page) is explained. The present embodiment can be applied to the variable print in which one set of printed matter has a plurality of pages. In this case, the page template declaration shown in FIG. 8 is prepared for each page of one set of printed matter.

In this embodiment, the case in which the original information for the variable part is characters, is explained. The original information may be an image registered in the database. In this case, in the object declaration, it is not required to describe the character type and the character size. Instead of these, for example, the information relating to the image size and the direction of the image may be described.

In the embodiment, the example of the system configuration in which the print data generating device 10 and the print device 30 are connected with each other in the same network 2, is shown. However, it is not required to connect them via the network. For example, the variable print data generated by the print data generating device 10 may be input the print device 30 by using a portable storing medium.

One of the objects of the above embodiment is to provide a print system, a print data generating device, a print device and a tangible computer-readable recording medium, which can reflect the contents of the updated database on the variable part in the variable print. Further, another object of the above embodiment is to provide a print system and the like which can shorten the time for generating the print data and the FPOT in the variable print in which the variable information is obtained from the database.

In the above embodiment, the print data generating device generates the variable print data including the search information for searching and obtaining the original information for a variable part from a database, and the print device carries out the search for searching the variable information in the database in accordance with the search information included in the variable print data and prepares the object of the variable part. Thereby, it is possible to obtain the variable printed matter in which the contents of the updated database are reflected on the variable part. Further, when the variable print data is prepared, the search for the database is not carried out and the object of the variable part is not prepared in accordance with the searched information obtained from the database. Therefore, it is possible to shorten the time for generating the variable print data and the data transfer time by the above process.

In the embodiment, in the process for preparing the print image, the intermediate data in which the contents are described in the page description language is generated. The intermediate data can be rasterized by a general-purpose expanding unit which complies with the page description language.

In the embodiment, because the process for preparing print image is started without waiting the finish of all of searches, it is possible to start the print promptly and to shorten the time for carrying out the process until the finish of the print.

In the embodiment, it is possible to convert the first variable print data generated in accordance with the conventional VDP application program to the variable print data according to the embodiment.

According to the print system, the print data generating device, the print device and the tangible computer-readable recording medium, it is possible to reflect the contents of the updated database on the variable part of the variable print.

What is claimed is:

1. A print system comprising a print data generating device generate a variable print data, and a print device to carry out a print in accordance with the variable print data generated by the print data generating device,
wherein the print data generating device generates and outputs the variable print data including search information for searching and obtaining original information for a variable part from a database; and
wherein the print device comprises:
an input unit to input the variable print data generated by the print data generating device;
a search unit to carry out a search for searching the original information in the database in accordance with the search information included in the variable print data which is input from the input unit;
a processing unit to prepare a print image in accordance with the variable print data by reflecting searched information obtained by the search unit on the variable part; and
a print unit to print the print image prepared by the processing unit.

2. The print system of claim 1, wherein the processing unit of the print device generates an intermediate data in which print contents of the variable part on which the searched information is reflected are described in a predetermined page description language, and
the processing unit generates the print image of the variable part by rasterizing the intermediate data.

3. The print system of claim 1, wherein in the print device, the search unit and the processing unit are operable in parallel, and the processing unit starts a process in accordance with the obtained searched information without waiting finish of the search carried out by the search unit.

4. The print system of claim 1, wherein the search information includes connection information for connecting the database, a field name of a field in which the original information to be extracted is stored and a search condition expression.

5. The print system of claim 1, wherein the variable print data includes layout information used as a template corresponding to a printed matter for one case of the searched information, and
the layout information for the variable part includes a field name indicating a source of the original information, format information and arrangement information indicating arrangement of the print image of the variable part in each page.

6. The print system of claim 1, wherein the print data generating device comprises:
a layout setting unit to receive setting of a layout of a variable printed matter;
a search information setting unit to receive setting of the search information for searching and obtaining the original information for the variable part in the variable printed matt in which the setting of the layout is received by the layout setting unit; and
a generating unit to generate and output the variable print data including layout information indicating the layout of which the setting is received by the layout setting unit, an object of a fixed part designated in the layout and the search information.

7. The print system of claim 1, wherein the print data generating device comprises:
a first input unit to input a first variable print data corresponding to at least one case of the searched information obtained from the database, the first variable print data having a data format including layout information for all pages, objects of all fixed parts, and objects of all variable parts, which are prepared in accordance with the searched information;
a search information setting unit to receive setting the search information for searching and obtaining the original information for preparing the objects of the variable parts, the database; and
a converting unit to extract layout information and the objects of all fixed parts, which correspond to one case of the searched information, from the first variable print data which is input by the first input unit, to convert the extracted layout information to layout information used as a template for preparing the objects of the variable parts in accordance with the searched information obtained from the database, and to generate and output the variable print data including the layout information used as the template, the search information and the extracted objects of all fixed parts.

8. A print data generating device to generate variable print data including search information for searching and obtaining original information for a variable part from a database.

9. The print data generating device of claim 8, comprising:
a layout setting unit to receive setting of a layout of a variable printed matter;
a search information setting unit to receive setting of the search information for searching and obtaining the original information for the variable part in the variable printed matter in which the setting of the layout is received by the layout setting unit; and
a generating unit to generate and output the variable print data including layout information indicating tfle layout of which the setting is received by the layout setting unit, an object of a fixed part designated in the layout and the search information.

10. The print data generating device of claim 8, wherein the search information includes connection information for connecting the database, a field name of a field in which the original information to be extracted is stored and a search condition expression.

11. The print data generating device of claim 8, wherein the variable print data includes layout information used as a template corresponding to a printed matter for one case of searched information, and
the layout information for the variable part includes a field name indicating a source of the original information, format information and arrangement information indicating arrangement of a print image of the variable part in each page.

12. A tangible computer-readable recording medium storing a program, wherein the program causes a computer function as a print data generating device to generate variable print data including search information for searching and obtaining original information for a variable part from database.

13. The tangible computer-readable recording medium of claim 12, wherein the program causes the computer to function as the print data generating device comprising:
a layout setting unit to receive setting of a layout of a variable printed matter;
a search information setting unit to receive setting of the search information for searching and obtaining the original information for the variable part in the variable printed matter in which the setting of the layout is received by the layout setting unit; and
a generating unit to generate and output the variable print data including layout information indicating the layout of which the setting is received by the layout setting unit, an object of a fixed part designated in the layout and the search information.

14. The tangible computer-readable recording medium of claim 12, wherein the search information includes connection information for connecting the database, a field name of a field in which the original information to be extracted is stored and a search condition expression.

15. The tangible computer-readable recording medium of claim 12, wherein variable print data includes layout information used as a template corresponding a printed matter for one case of searched information, and
the layout information for the variable part includes a field name indicating a source of the original information, at information and arrangement information indicating arrangement of a print image of the variable part in each page.

16. A print device, comprising:
an input unit to input a variable print data including search information for searching and obtaining original information for a variable part from a database;
a search unit to carry out a search for searching the original information in the database in accordance with the search information included in the variable print data which is input from the input unit;
a processing unit to prepare a print image in accordance with the variable print data by reflecting searched information obtained by the search unit on the variable part; and
a print unit to print the print image prepared by the processing unit.

77. The print device claim 16, wherein the processing unit generates an intermediate data in which print contents the variable part on which the searched information is reflected are described in a predetermined page description language, and
the processing unit generates the print image of the variable part by rasterizing the intermediate data.

18. The print device of claim 16, wherein the search unit and the processing unit are operable in parallel, and the processing unit starts a process in accordance with the obtained searched information without waiting finish of the search carried out by the search unit.

19. A tangible computer-readable recording medium storing a program, wherein the program causes a computer to function as:
a first input unit to input a first variable print data corresponding to at least one case of searched information obtained from a database, the first variable print data having a data format including layout information for all pages, objects of all fixed parts, and objects of all variable parts, which are prepared in accordance with the searched information;
a search information setting unit to receive setting of search information for searching and obtaining original information for preparing the objects of the variable parts, from the database; and
a converting unit to extract layout information and the objects of all fixed parts, which correspond to one case of the searched information, from the first variable print data which is input by the first input unit, to convert the extracted layout information to layout information used as a template for preparing the objects of the variable parts in accordance with the searched information obtained from the database, and to generate and output the variable print data including the layout information used as the template, the search information and the extracted objects of all fixed parts.
